(19) United States
(12) Patent Application Publication
(10) Pub. No.: US 2025/0229800 A1
(43) Pub. Date: Jul. 17, 2025

(54) DRIVER CAPABILITY MONITORING

(71) Applicant: Bendix Commercial Vehicle Systems LLC, Avon, OH (US)

(72) Inventor: Thomas J. Hayes, Lakewood, OH (US)

(21) Appl. No.: 18/411,275

(22) Filed: Jan. 12, 2024

(51) Int. Cl. B60W 60/00; B60W 50/10; B60W 50/14

(52) U.S. Cl. CPC B60W 60/001; B60W 50/10; B60W 50/14

(57) ABSTRACT

In accordance with one embodiment, a vehicle system for a vehicle capable of being both autonomously driven and human driven comprises a plurality of sensors on the vehicle for transmitting information about the vehicle environment and the response of the vehicle to actions implemented by at least one of the autonomous control and the human control and a controller for implementing automated control on the vehicle. The controller has an input for receiving vehicle information from the plurality of sensors, a memory for storing vehicle response results when the vehicle is under human control and an autonomous driving model; and control logic for comparing the information of the vehicle response results when under human control to the autonomous driving model. The control logic switches to autonomous control when the vehicle driving response results under human control are not reasonably comparable to the autonomous driving model.

### BACKGROUND

The present application relates to a system, controller and method to monitor the driving capability of a human driver of a vehicle equipped with autonomous driving functions. The system will adjust vehicle operation based on the driving capability information.

In commercial vehicle applications having autonomous driving functions, the need for human driver intervention changes based on the abilities of the autonomous driving functions. The autonomous driving functions may be more advantageous in certain driving situations. The operation of the autonomous functions of the vehicle can be compared with the operation of the same vehicle under a human driver. Therefore, there is interest in improving the functionality of commercial vehicles having autonomous functions and identifying when a human driver can take over driving the vehicle from the autonomous controller.

### SUMMARY

In accordance with one embodiment, a vehicle system for a vehicle capable of being both autonomously driven and human driven comprises a plurality of sensors on the vehicle for transmitting information about the vehicle environment and the response of the vehicle to actions implemented by at least one of the autonomous control and the human control and a controller for implementing automated control on the vehicle. The controller has an input for receiving vehicle information from the plurality of sensors, a memory for storing vehicle response results when the vehicle is under human control and an autonomous driving model; and control logic for comparing the information of the vehicle response results when under human control to the autonomous driving model. The control logic switches to autonomous control when the vehicle driving response results under human control are not reasonably comparable to the autonomous driving model.

In accordance with another embodiment, a method for controlling a vehicle comprises receiving information about the vehicle environment and the response of the vehicle to action implemented by at least one of the autonomous control and the human control from associated sensors on the vehicle; storing vehicle response information when the vehicle is under human control and comparing the information of the vehicle response when under human control to an autonomous driving model. The method will switch to automated control in response to the vehicle results under human control not being reasonably comparable to the autonomous driving model.

### BRIEF DESCRIPTION OF THE DRAWINGS

FIG. 1 is a representation of a system on a commercial vehicle according to one example of the present invention.

FIG. 2 is a flowchart of the operation of the system as in FIG. 1.

### DETAILED DESCRIPTION

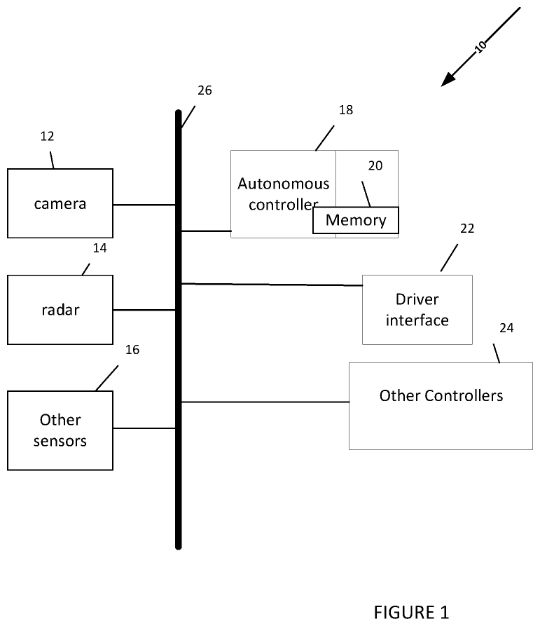

Referring to FIG. 1, a system 10 for a commercial vehicle according to one example of this invention is shown. The system 10 includes components for enabling and controlling autonomous vehicle functions. The system 10 includes components for monitoring the operation of a vehicle when under human driving control. The components may be the same for both autonomous and driver-controlled functions.

The system 10 includes at least one camera 12. The camera 12 may be a forward-looking camera for viewing the area in front of the vehicle. The video signals of camera 12 may be analyzed within the camera 12 or within another controller on the vehicle to detect an object's presence, size, longitudinal distance and lateral distance with respect to the vehicle. The camera 12 may include pedestrian identification and road sign recognition capabilities. In another embodiment, multiple cameras can be used on a single vehicle. A driver facing camera may be one of the multiple cameras. The driver facing camera is used to monitor the actions of the driver of the vehicle. The cameras can be mounted on the vehicle to detect, via image signal interpretation, multiple stationary or moving objects within a wide range to the front, side and rear of the vehicle, as well as movement within the interior of the vehicle.

The vehicle system 10 includes at least one radar 14, which may be a forward looking or side looking radar. The radar 14 transmits and receives radar signals, which are electromagnetic waves. The signals of radar 14 may be analyzed within the radar 14 or within another controller on the vehicle to detect an object's presence, longitudinal distance, lateral distance, speed and direction with respect to the vehicle. The radar 14 can detect multiple stationary or moving objects within a wide range to the front and sides of the vehicle. Alternatively, a LIDAR, ultrasonic or other sensing technology may be used to detect the presence of objects around the vehicle.

The vehicle system 10 includes other sensors 16 for determining other operations of the vehicle. The other sensors and systems throughout the vehicle are used to monitor vehicle functions and provide input data indicative of one or more operating parameters of one or more conditions of the vehicle. For example, the other sensors 16 may be, but not limited to, one or more wheel speed sensors, one or more multi-axis acceleration sensors, a steering angle sensor, a brake pressure sensor, one or more vehicle load sensors, a yaw rate sensor, a lane departure warning (LDW) sensor or system, a Global Positioning System, an inertial measurement sensor, one or more engine speed or condition sensors, and a tire pressure (TPMS) monitoring system.

The vehicle system 10 includes a driver interface 22. The driver interface 22 may be a warning lamp, an audible system, a display or other device, such as one that includes a haptic function, which communicates additional information to the driver. The driver interface 22 may include an input, such as a switch, for the driver to activate or deactivate a component or function of the vehicle system 10.

The vehicle system 10 includes an autonomous function controller 18. The autonomous function controller 12 may perform autonomous or semi-autonomous vehicle functions, such as platooning, lane keeping, automatic emergency braking, adaptive cruise control, lane centering, automated steering control and highway departure braking under certain conditions. The autonomous function controller 18 may perform braking functions for anti-lock braking and stability control, if integrated with a braking system controller.

The controller 18 includes a processor with control logic for interpreting the vehicle signals and other information. The automated driving controller 18 includes a memory 20 for storing at least one autonomous driving model. The autonomous driving model may be ideal driving results, such as following distance and stopping distance as developed by an insurance company or fleet safety manager for the type of vehicle. Alternatively, the vehicle manufacturer or autonomous function controller manufacturer may include the autonomous driving model in the memory 20 as part of the original vehicle configuration. In another embodiment, the controller 18 records into memory the vehicle response while under autonomous control and stores as the autonomous driving model in memory. In another embodiment, the autonomous driving model may be preconfigured based on vehicle simulations or predefined road conditions.

The memory 20 also collects the human driving response results from the camera 12, radar 14, other sensors 16 and other controllers 24. The control logic communicates with the memory 20, which may include volatile memory, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic of the controller 18. The control logic includes a timer function.

The controller 18 may include inputs for receiving the signals directly from the camera 12 and radar 14, and other sensors 16. The controller 18 may directly control the driver interface 22.

The vehicle system 10 includes other controllers 24, which may include braking system controller, steering system controller and engine controller, for example. The functions of the controllers may be combined into a single controller, such as the autonomous function controller 18 or may remain separate controllers.

The vehicle system 10 includes a communications bus 26, which may use SAE J1939 CAN or other protocol. The controller 18 includes a communications port for communicating with the vehicle communication bus 26. Each of the components, such as the camera 12, the radar 14, the other sensors 16, the driver interface 22, autonomous function controller 18 and other controllers 24 of the vehicle system 10 may be connected to the communications bus 26. Alternatively, wireless communication may be used among all the components on the vehicle.

Controller 18 responds to signals from sensors, such as camera 12, radar 14 and other sensors 16. The controller 18 may also respond to messages received from other controllers 24 on the vehicle. The controller 18 transmits signals via the serial communications bus 26 or directly to the other controllers 24 to maintain driving functions, such as acceleration and deceleration. The controller 18 may also communicate with a driver interface 22 to indicate the status of the automated driving system.

The camera 12, radar 14 and other sensors 16 measure the human driving response results when he is driving the vehicle. The information is stored in the memory 20 for comparison with the autonomous driving model already stored in memory 20. Alternatively, the memory 20 includes measurements from when the autonomous function controller 18 is implementing autonomous driving functions.

Therefore, a vehicle system for a vehicle capable of being both autonomously driven and human driven comprises a plurality of sensors on the vehicle for transmitting information about the vehicle environment and the response of the vehicle to actions implemented by at least one of the autonomous control and the human control and a controller for implementing automated control on the vehicle. The controller has an input for receiving vehicle information from the plurality of sensors, a memory for storing vehicle response results when the vehicle is under human control and an autonomous driving model; and control logic for comparing the information of the vehicle response results when under human control to the autonomous driving model.

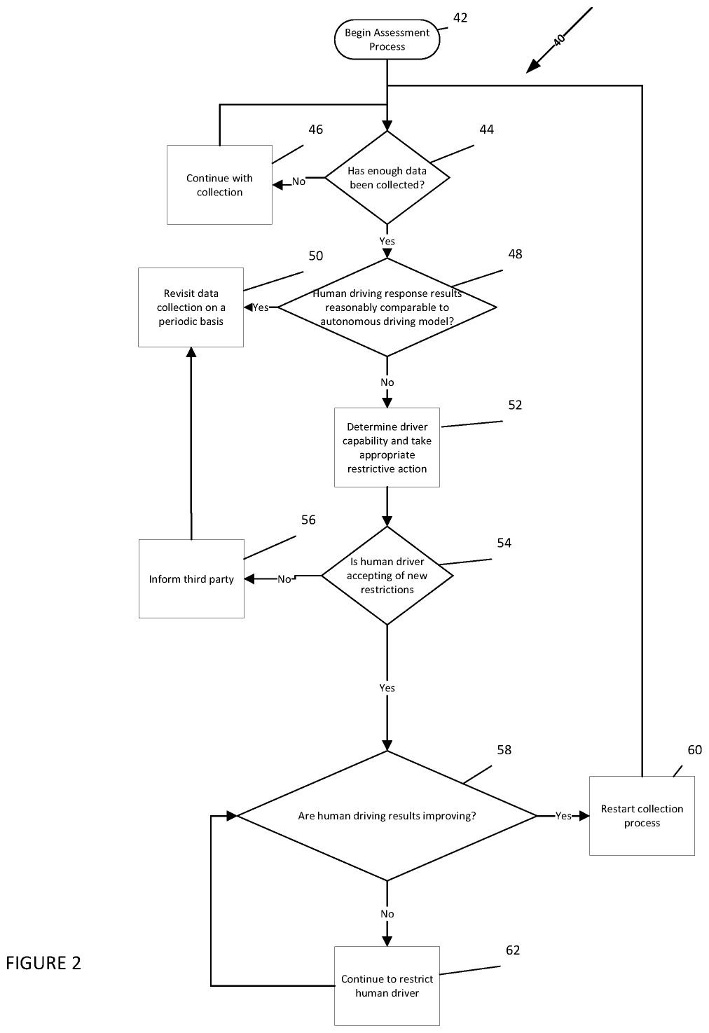

FIG. 2 illustrates a method 40 for a vehicle having the system 10 to determine whether a human driver should be allowed to manually drive the host vehicle under certain circumstances. The method 40 begins with step 42, when the assessment process is initiated by the control logic in the autonomous function controller 18. The assessment process can be run each time the vehicle is powered, each time the human driver is in control of the vehicle, or the process can be requested by another controller on the vehicle. The driver may indicate that he wants to manually drive via the driver interface 22 or the autonomous controller 18 may determine that the manual drive can proceed.

In step 44, the controller 18 receives a set of vehicle response factors from the camera 12, the radar 14 and the other sensors 16 on the vehicle. The vehicle response factors include, for example, following distance, acceleration, deceleration, braking force, lane keeping, and driver's reaction time to external events, such as a traffic light turning red. The controller 18 determines whether enough data has been collected in order to make a comparison. For example, in one embodiment, the duration of collecting vehicle information may be of any predetermined duration, such as 5 minutes, 30 minutes, a full day and the like. The intent is to collect enough data to compare the human driving response results to the autonomous driving model in memory 20. Alternatively, the data may be collected until there is on or more of a human driving response result that is not reasonably comparable to the autonomous driver model. Reasonable comparison means that the response is near to the automated driving model and any difference does not affect the safe operation of the vehicle.

If the data reaches a minimum amount to evaluate the operation, the method 40 continues to step 48. If the controller 18 does not have enough information, the method 40 continues with the collection in step 46 and then returns to step 44.

In step 48, the controller 18 determines whether the set of vehicle response results from the human driver collected are reasonably comparable to the autonomous driving model. The controller 18 is determining whether the human driver has sufficient capabilities to drive on the road by measuring the human driving response results to certain events, such as how the driver interacts with traffic around the vehicle. The controller 18 is monitoring the driver's behavior in specific situations. The information collected using the camera 12, radar 14, and other sensors 16 as well as other vehicle controllers 24 includes braking response time, following distance, braking force, lane keeping, lane changing aggression, distance when merging and interactions with non-vehicle elements such as cyclist and pedestrians, for example.

A driver behavior model may be fitted to each individual block of data that is in the vehicle memory 20 as the autonomous driving model. A driver behavior model may be matched to each block based on these values. Excessive delay in a brake apply may mean the driver is not reacting soon enough. Insufficient corrective force, in the case of braking, may mean the driver does not slow down sufficiently to avoid a collision, or not manipulating the steering wheel sufficiently to avoid hitting a median or barrier. In step 48, the system may evaluate whether the driver's pattern of behavior, is reasonably comparable to the autonomous driving model or that the driver's pattern of behavior may risk the safety of the vehicle, its occupants and to other vehicles sharing the roadway.

If the respective human driving response results are reasonably comparable to the autonomous driving model in memory 20, the controller 18 will allow the vehicle to be run in either manual mode or autonomous mode at the discretion of the human driver. Reasonable comparisons mean that there would be no impact to the safety of the vehicle or how the vehicle is operating in traffic. The method 40 continues to step 50 where the data collection can be revisited on a periodic basis.

However, if the human driving response results are not reasonably comparable to the autonomous driving model, the controller 18 determines the driver's capability and will take appropriate restrictive action in step 52. Restrictive actions include only allowing automated control in a restricted zone, such as a school zone or construction zone or limiting the speed of the vehicle when the vehicle is under human control using autonomous mode in heavy traffic. The method 40 continues to step 54 to obtain the human driver's acceptance of the restrictions through the driver interface unit 22. The driver may be asked to confirm his understanding that he will not be allowed to manually drive or at least manually drive in a defined zone. If the driver accepts the limitation, the method continues to step 58. If the driver rejects the restrictions in step 54, the method continues to step 56 where third parties, such as the fleet manager or the insurance company, are informed of the driver's decision. The driver may be considered a high-risk driver, or his driving habits may be monitored more closely. However, the driver will still be allowed to manually operate the vehicle. From step 56, the method 40 goes to step 50 to revisit data collection on a periodic basis.

In step 58, the system 10 continues with autonomous control, which may be a restriction on speed or only manual driving outside of designated zones. The human driving response results are compared to the autonomous driving model in the memory 20. If the human driving response results are improving over the past data collection and is moving closer to the autonomous driving model, then the method continues to step 60. In step 60, the process is restarted and returns to step 44 to collect driver response data to determine if any new restrictive actions must be taken.

If the driver's behavior/response is not improved over the data stored in the memory 20, then in step 62 the driver's ability to manually operate the vehicle will be restricted again and the autonomous functions will remain active. The method returns to step 58 to continue to monitor the driver operation of the vehicle and compare to the autonomous driving model.

Therefore, a method for controlling a vehicle comprises receiving information about the vehicle environment and the response of the vehicle to action implemented by at least one of the autonomous control and the human control from associated sensors on the vehicle; storing vehicle response information when the vehicle is under human control and comparing the information of the vehicle response when under human control to an autonomous driving model. The method will switch to automated control in response to the vehicle results under human control not being reasonably comparable to the autonomous driving model.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A vehicle system for a vehicle capable of being both autonomously driven and human driven comprising:
a plurality of sensors on the vehicle for transmitting information about the vehicle environment and the response of the vehicle to actions implemented by at least one of the autonomous control and the human control;
a controller for implementing automated control on the vehicle, the controller having:
an input for receiving vehicle information from the plurality of sensors;
a memory for storing an autonomous driving model and vehicle response results when the vehicle is under human control; and
control logic for comparing the information of the vehicle response results when under human control to the autonomous driving model, wherein the control logic switches to autonomous control when the vehicle driving response results under human control are not reasonably comparable to the autonomous driving model.

2. The system as in claim 1, wherein the control logic further indicates to the human driver that the autonomous control has been activated.

3. The system as in claim 1, wherein the human driver can override the autonomous control and the memory will record the human override action.

4. The system as in claim 1, wherein the response of the vehicle information collected includes at least one of braking force, following distance to a forward vehicle, lane keeping, distance to a non-vehicle obstacle and speed in special zones.

5. The system as in claim 1, wherein the autonomous driving model is created from vehicle information when the vehicle is under autonomous control.

6. The system as in claim 1, wherein the autonomous driving model is loaded into the memory of the controller by one of a manufacturer of the vehicle, a fleet manager and an insurance company.

7. A controller for implementing automated driving functions on a vehicle, the vehicle being capable of both autonomous control and human control comprising:
an input for receiving information about the vehicle environment and the response of the vehicle to action implemented by at least one of the autonomous control and the human control from associated sensors on the vehicle;
a memory for storing vehicle response information when the vehicle is under human control and an autonomous driving model; and
control logic for comparing the information of the vehicle response when under human control to vehicle results when the vehicle is under autonomous control, wherein the control logic switches to automated control if the vehicle results under human control is not reasonably comparable to the vehicle results under autonomous control.

8. A method for controlling a vehicle comprising:
receiving information about the vehicle environment and the response of the vehicle to action implemented by at least one of the autonomous control and the human control from associated sensors on the vehicle;
storing vehicle response information when the vehicle is under human control;
comparing the information of the vehicle response when under human control to an autonomous driving model; and
switching to automated control in response to the vehicle results under human control not being reasonably comparable to the autonomous driving model.

9. The method as in claim 8, wherein switching to automated control occurs in a restricted driving zone.

10. The method as in claim 8, wherein switching to automated control means that the speed of the vehicle when under human control is limited to a predetermined speed.

11. The method as in claim 8, further comprising: creating the autonomous driving model while the vehicle is under autonomous control and storing the autonomous driving model in a memory for comparison to the vehicle response when under human control.

12. The method as in claim 8, further comprising: entering a preconfigured autonomous driving model and storing the autonomous driving model in a memory for comparison to the vehicle response when under human control.
